(19) United States
(12) Patent Application Publication
(10) Pub. No.: US 2026/0200306 A1
(43) Pub. Date: Jul. 16, 2026

(54) VEHICLE UNDERBODY STRUCTURE

(71) Applicant: TOYOTA JIDOSHA KABUSHIKI KAISHA, Toyota-shi (JP)

(72) Inventor: Kazuaki KOIDE, Gifu-shi (JP)

(21) Appl. No.: 19/348,002

(22) Filed: Oct. 2, 2025

(30) Foreign Application Priority Data
Jan. 15, 2025 (JP) 2025-005372

(51) Int. Cl. B60K 1/04; B62D 21/02

(52) U.S. Cl. CPC B60K 1/04; B62D 21/02; B60K 2001/0438

(57) ABSTRACT

A vehicle underbody structure includes: a vehicle frame including a pair of side frames extending in a first direction; a battery pack disposed in an area surrounded by the side frames, a first kick portion provided on one side of the vehicle frame in the first direction, and a second kick portion provided on the other side of the vehicle frame in the first direction; a connecting member that connects the battery pack to intermediate portions of the side frames in the first direction; and a roll mechanism that connects, to the second kick portion, a central portion of the battery pack in a second direction intersecting the first direction on the other side in the first direction to rotate about a rotation axis extending in the first direction.

### CROSS-REFERENCE TO RELATED APPLICATION

This application claims priority to Japanese Patent Application No. 2025-005372 filed on January 15, 2025. The disclosure of the above-identified application, including the specification, drawings, and claims, is incorporated by reference herein in its entirety.

### BACKGROUND

### 1. Technical Field

The technology of the present disclosure relates to a vehicle underbody structure.

### 2. Description of Related Art

In recent years, as battery electric vehicles (BEVs) and hybrid electric vehicles (HEVs) have become widespread, there has been an increasing demand to mount large-size battery packs in vehicles while saving space.

For example, Japanese Unexamined Patent Application Publication No. 2021-123227 (JP 2021-123227 A) describes a structure in which a battery pack case in which a plurality of battery cells is disposed is fixed to the floor of a vehicle.

### SUMMARY

BEVs and HEVs have become widespread not only as passenger cars but also as commercial vehicles such as trucks and buses. Many commercial vehicles such as trucks use a frame structure rather than a monocoque structure. Since the frame used in the frame structure is shaped substantially as framework, the frame is more susceptible to torsion than the monocoque structure. Therefore, when adopting a structure in which a battery pack is disposed on the floor of a vehicle having a frame structure as in JP 2021-123227 A, it is important that the effect of torsion described above be taken into consideration. There is still room for improvement in this regard.

In view of the above issue, the present disclosure has an object to provide a vehicle underbody structure that suppresses the effect of torsion of a vehicle frame on a battery pack.

To achieve the above object, a vehicle underbody structure according to claim 1 includes: a vehicle frame including a pair of side frames extending in a first direction; a battery pack disposed in an area surrounded by the side frames, a first kick portion provided on one side of the vehicle frame in the first direction, and a second kick portion provided on the other side of the vehicle frame in the first direction; a connecting member that connects the battery pack to intermediate portions of the side frames in the first direction; and a roll mechanism that connects, to the second kick portion, a central portion of the battery pack in a second direction intersecting the first direction on the other side in the first direction to rotate about a rotation axis extending in the first direction.

In the vehicle underbody structure according to claim 1, the battery pack is supported on the vehicle frame by the connecting member and the roll mechanism. Therefore, when torsion occurs in the vehicle frame, the bending stress caused by the torsion is less likely to be transmitted to the battery pack. Thus, it is possible to avoid damage etc. to the battery pack due to the bending stress.

In a vehicle underbody structure according to claim 2, in the vehicle underbody structure according to claim 1, an end of the battery pack on the other side in the first direction is located on the other side in the first direction relative to an end of the second kick portion that is closer to the battery pack.

In the vehicle underbody structure according to claim 2, a large-size battery pack can be used in the area where the battery pack is disposed, and a large-capacity battery pack can be mounted while saving space.

With the above vehicle underbody structure, it is possible to suppress or avoid the effect of torsion of the vehicle frame on the battery pack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing an example of a vehicle underbody structure according to an embodiment;

FIG. 2A is an explanatory diagram illustrating torsion that may occur in the vehicle underbody structure according to the embodiment; and

FIG. 2B is an explanatory diagram illustrating torsion that may occur in the vehicle underbody structure according to the embodiment.

### DETAILED DESCRIPTION OF EMBODIMENTS

Hereinafter, embodiments of the present disclosure will be described with reference to the drawings. In the following, description will be given schematically about a scope necessary for achieving the object of the present disclosure, focusing on relevant parts of the present disclosure, and description will be omitted for parts that are based on known technologies. Identical or corresponding components in the drawings are denoted by the same or similar signs, and redundant descriptions will be omitted. When a plurality of identical or corresponding components is included in the drawings, only some of them may be denoted by the signs for clarity of illustration.

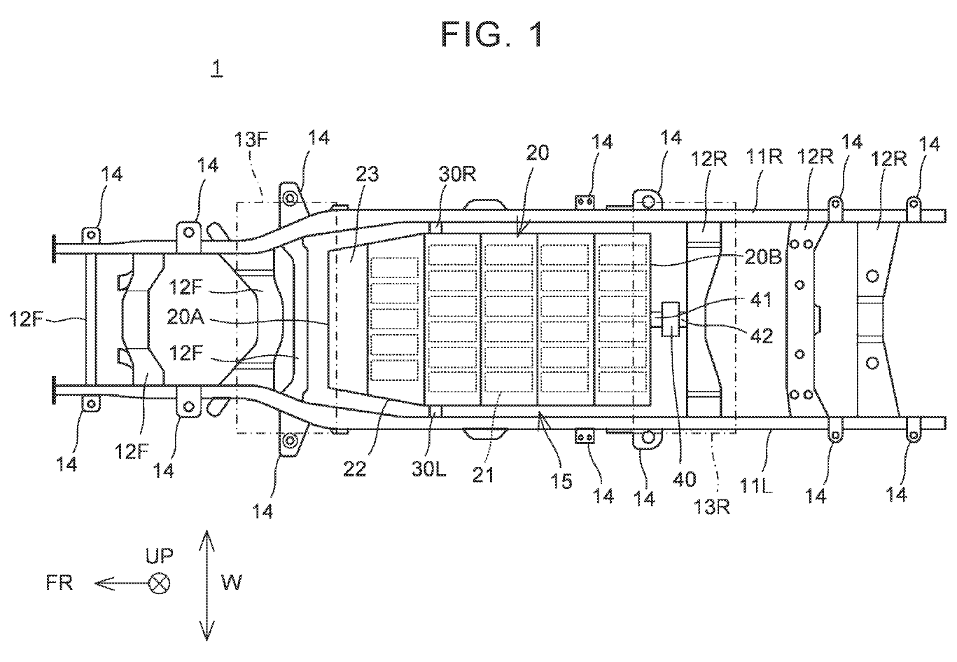

FIG. 1 is a plan view showing an example of a vehicle underbody structure according to an embodiment. The vehicle underbody structure 1 according to the present embodiment refers to a vehicle frame provided under a vehicle having a frame structure and its surrounding structure. In the following description, the direction indicated by arrow FR in FIG. 1 is a front-rear direction, the direction indicated by arrow W is a right-left direction, and the direction indicated by arrow UP is an up-down direction. The front-rear direction is an example of the "first direction" and the right-left direction is an example of the "second direction." Arrow FR corresponds to the forward direction of the vehicle, and arrow W corresponds to the width direction of the vehicle.

As shown in FIG. 1, the vehicle underbody structure 1 according to the present embodiment includes at least a vehicle frame 10 that is a so-called ladder frame, and a battery pack 20 mounted on the vehicle.

The vehicle frame 10 includes at least a pair of side frames 11L, 11R extending in the front-rear direction. The vehicle frame 10 of the present embodiment may also include a plurality of cross members 12F, 12R extending in the right-left direction and connecting the side frames 11L, 11R.

The side frames (sometimes referred to as "side members") 11L, 11R may be members that are elongated in the front-rear direction and disposed substantially parallel to each other at a predetermined distance in the right-left direction. The side frames 11L, 11R can be made of steel, an aluminum alloy, etc. with a box-shaped or C-shaped cross section.

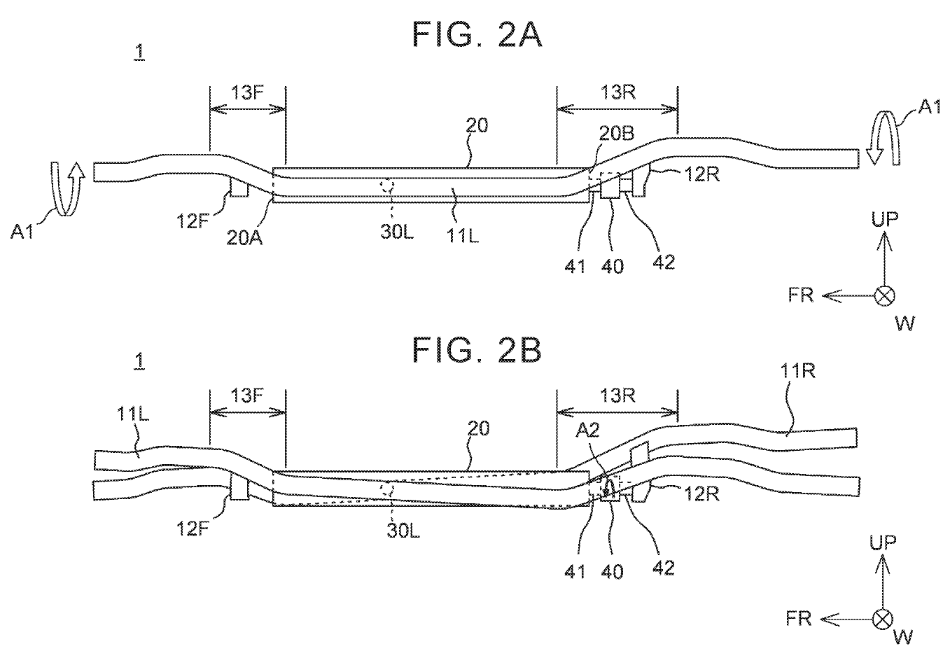

The front sides of the side frames 11L, 11R, more specifically, the front sides of the side frames 11L, 11R rearward of the position where front wheels (not shown) of the vehicle are attached, may be kicked up obliquely forward (see FIG. 2A). The area including the portion of the vehicle frame 10 that is kicked up obliquely forward will be referred to as "front kick portion 13F" that is an example of a first kick portion. Similarly, the rear sides of the side frames 11L, 11R, more specifically, the rear sides of the side frames 11L, 11R forward of the position where rear wheels (not shown) of the vehicle are attached, may be kicked up obliquely rearward (see FIG. 2A). The area including the portion of the vehicle frame 10 that is kicked up obliquely rearward will be referred to as "rear kick portion 13R" that is an example of a second kick portion.

The cross members 12F, 12R may be members that join the side frames 11L, 11R in the right-left direction. The cross members may have various shapes such as a tubular shape, a U-shape, a plate shape, or a box shape, and are used to relieve stress concentration in the side frames 11L, 11R and improve torsional rigidity. A plurality of cross members 12F, 12R is provided to support other components mounted on the vehicle, such as a suspension system and a fuel tank. The cross members 12F, 12R and the side frames 11L, 11R are firmly joined using rivets, bolts, welding, or other methods.

In the present embodiment, the exemplified cross members 12F, 12R include one or more (e.g., four) front cross members 12F disposed at the front of the vehicle and one or more (e.g., three) rear cross members 12R disposed at the rear of the vehicle. The front kick portion 13F includes at least one of the front cross members 12F. Similarly, the rear kick portion 13R includes at least one of the rear cross members 12R.

Brackets 14 for supporting the body and various components of the vehicle may be formed at the side frames 11L, 11R or the cross members 12F, 12R. The shapes and dispositions of the brackets 14 shown in FIG. 1 are merely examples, and may be adjusted as appropriate depending on the structure of the vehicle and the layout of various components.

The battery pack 20 is disposed in an area of the vehicle frame 10 that is surrounded by the side frames 11L, 11R, the front kick portion 13F, and the rear kick portion 13R. Hereinafter, the area surrounded by the side frames 11L, 11R, the front cross member 12F provided in the front kick portion 13F, and the rear cross member 12R provided in the rear kick portion 13R will be referred to as "battery pack housing space 15."

The battery pack housing space 15 is located under the floor. Therefore, a relatively large space can be secured, and a large-capacity battery pack 20 can be mounted while saving space. Since the battery pack housing space 15 is disposed at the center of the vehicle frame 10 in the longitudinal direction, the amount of displacement due to torsion is smaller than that at the end of the vehicle frame 10 in the longitudinal direction. Therefore, the battery pack housing space 15 is an area where the effect of torsion of the vehicle frame 10 on the battery pack 20 is small.

The battery pack 20 disposed in the battery pack housing space 15 may include a plurality of battery cells 21 and a battery pack case 22 that houses the battery cells 21. It is appropriate that a front end 20A of the battery pack 20 face the front cross member 12F included in the front kick portion 13F at a predetermined distance. It is appropriate that a rear end 20B of the battery pack 20 face the rear cross member 12R included in the rear kick portion 13R at a predetermined distance.

The battery cell 21 may be, for example, a rectangular cell elongated in one direction. The battery cell 21 may be a lithium ion battery, a lithium iron phosphate (LFP) battery, an all-solid-state battery, etc., but the type of the battery is not particularly limited. The shape of the battery cell 21 is not limited to the rectangular shape, but may be a cylindrical or pouch shape.

The battery pack case 22 may be a housing in which the battery cells 21 are disposed and that covers at least part of the battery cells 21. FIG. 1 illustrates the battery cells 21 arranged in a plurality of rows in the right-left direction inside the battery pack case 22, but the layout and number of the battery cells 21 are not particularly limited. A mechanical component 23 for controlling the charging and discharging of the battery pack may be installed at an appropriate position in the battery pack 20. The mechanical component 23 is preferably fastened and fixed to the battery pack 20 in a manner that minimizes the transmission of vibrations. In the present embodiment, the mechanical component 23 is disposed at the upper front portion of the battery pack 20.

To support the battery pack 20 within the battery pack housing space 15, the vehicle underbody structure 1 of the present embodiment includes connecting members 30L, 30R that connect the battery pack 20 to intermediate portions of the side frames 11L, 11R in the front-rear direction, and a roll mechanism 40 that rotatably connects a central portion in the width direction at the rear of the battery pack 20 (corresponding to the "other side in the first direction") to the rear kick portion 13R.

The connecting members 30L, 30R may be support pieces extending in the right-left direction to connect the right and left side surfaces of the battery pack case 22 to the intermediate portions of the side frames 11L, 11R in the front-rear direction, more specifically, the inner surfaces facing the battery pack housing space 15. The connecting members 30L, 30R of the present embodiment may be integrated with the battery pack case 22, with their distal ends fastened and fixed to the side frames 11L, 11R. The fixing structure of the connecting members 30L, 30R is not limited to the above structure, and may be modified as appropriate.

The inner surfaces of the side frames 11L, 11R that face the battery pack housing space 15 are surfaces located at the middle of the vehicle frame 10 in the longitudinal direction. Therefore, the amount of displacement of these surfaces in the event of torsion is smaller than that of both ends of the vehicle frame 10 in the longitudinal direction. By connecting the connecting members 30L, 30R to the inner surfaces of the side frames 11L, 11R that face the battery pack housing space 15, the bending stress caused by torsion of the vehicle frame 10 is less likely to be transmitted to the battery pack 20. It is more preferable that the positions on the side frames 11L, 11R where the connecting members 30L, 30R are joined be selected and set to be the positions on the inner surfaces facing the battery pack housing space 15 where the amount of displacement is smaller in the event of torsion of the vehicle frame 10. In the present embodiment, each single connecting member 30L, 30R extends from the right or left side surface of the battery pack 20, but a plurality of connecting members may be disposed on the right or left side surface of the battery pack 20. The joining positions of the connecting members 30L, 30R and the battery pack case 22 may be changed as appropriate.

The roll mechanism 40 connects a central portion of the rear end 20B of the battery pack 20 in the right-left direction to the rear kick portion 13R to be rotatable about a rotation axis (not shown) extending in the front-rear direction. The roll mechanism 40 may be disposed in a space between the rear end 20B of the battery pack 20 and the rear cross member 12R provided in the rear kick portion 13R. A first shaft 41 is connected to the front of the roll mechanism 40, and extends rearward from the central portion of the rear end 20B of the battery pack 20 in the right-left direction. A second shaft 42 is connected to the rear of the roll mechanism 40, and extends forward from a central portion of the rear cross member 12R provided in the rear kick portion 13R in the right-left direction. The lengths of the first shaft 41 and the second shaft 42, etc. are preferably adjusted such that the large-size battery pack 20 is disposed in the battery pack housing space 15.

The roll mechanism 40 can be implemented by a known rotation mechanism such as a rotary joint. The first shaft 41 and the second shaft 42 are connected via the roll mechanism 40 to rotate relative to each other about the rotation axis extending in the front-rear direction. In relation to this, the battery pack 20 to which the first shaft 41 is connected and the rear cross member 12R to which the second shaft 42 is connected are also connected to rotate relative to each other.

FIGS. 2A and 2B are explanatory diagrams illustrating torsion that may occur in the vehicle underbody structure according to the embodiment. FIG. 2A is a schematic diagram of the vehicle underbody structure viewed from the left side when no torsion has occurred. FIG. 2B is a schematic diagram showing a state in which torsion has occurred in the vehicle underbody structure shown in FIG. 2A. Referring to FIGS. 2A and 2B, description will be given of the state of each part when torsion occurs in the vehicle frame 10 in the vehicle including the vehicle underbody structure 1 having the above configuration. In FIGS. 2A and 2B, the vehicle frame 10 is shown particularly schematically for clarity of the state of each component in the event of torsion.

When the vehicle including the vehicle underbody structure 1 is traveling, for example, on a paved, substantially level road, significant torsion hardly occurs in the vehicle frame 10 and the side frames 11L, 11R maintain a substantially parallel state as shown in FIG. 2A. Therefore, the battery pack 20 supported by the vehicle frame 10 also maintains a horizontal posture, and the roll mechanism 40 supports the rear end 20B of the battery pack 20 without rotating.

When the vehicle travels on a rough road such as an unpaved road, a difference may occur in the positions of the right and left wheels in the up-down direction to cause significant torsion in the vehicle frame 10. For example, when the front of the vehicle rolls in one direction and the rear of the vehicle rolls in the opposite direction to the one direction during traveling on a rough road as indicated by arrows A1 in FIG. 2A, significant torsion occurs in the vehicle frame 10. When the torsion occurs, as shown in FIG. 2B, one side frame 11L is displaced upward and the other side frame 11R is displaced downward in the front kick portion 13F, and one side frame 11L is displaced downward and the other side frame 11R is displaced upward in the rear kick portion 13R. Thus, torsion occurs in the vehicle frame 10.

When the torsion occurs in the vehicle frame 10, the rear cross member 12R in the rear kick portion 13R rolls along with the displacement of the rear kick portion 13R, and the second shaft 42 rolls following the rear cross member 12R. Since the second shaft 42 is connected to the roll mechanism 40, the roll of the second shaft 42 is absorbed by the roll mechanism 40 when the roll mechanism 40 rotates in the direction of arrow A2 in FIG. 2B, and is not transmitted to the first shaft 41 and the battery pack 20. Since the connecting members 30L, 30R that support the sides of the battery pack 20 are fastened in advance at the positions where the amount of displacement due to torsion is small, the displacement of the side frames 11L, 11R hardly changes the posture of the battery pack 20 via the connecting members 30L, 30R. Therefore, even when the torsion shown in FIG. 2B occurs in the vehicle frame 10, the battery pack 20 can be held in the battery pack housing space 15 without substantially changing the posture. The direction of torsion does not matter in the roll absorption by the roll mechanism 40.

As described above, the vehicle underbody structure 1 of the present embodiment has the structure in which the battery pack 20 is supported via the connecting members 30L, 30R and the roll mechanism 40. Therefore, even when torsion occurs in the vehicle frame 10, the transmission of bending stress to the battery pack 20 can be significantly suppressed or substantially avoided. Thus, it is possible to avoid damage etc. to the battery pack 20 due to torsion of the battery pack 20 together with the vehicle frame 10.

As described above, when torsion occurs in the vehicle frame 10 in the vehicle having the frame structure, the amounts of displacement at the positions on the side frames 11L, 11R corresponding to the rear kick portion 13R and the front kick portion 13F tend to relatively increase. Therefore, it is difficult to dispose the battery pack 20 at the position corresponding to the rear kick portion 13R or the front kick portion 13F. As described above, the vehicle underbody structure 1 of the present embodiment has the structure in which the bending stress caused by torsion of the vehicle frame 10 is less likely to be transmitted to the battery pack 20. Therefore, the battery pack 20 can be disposed, for example, at the position corresponding to the rear kick portion 13R. Specifically, the battery pack 20 can be disposed up to a position where the rear end 20B is rearward of the position of the front end of the rear kick portion 13R.

With the above configuration, the large-size battery pack 20 can be disposed in the battery pack housing space 15, thereby improving space efficiency. Therefore, the large-capacity battery pack 20 can be mounted on the vehicle while saving space. For the same reason, the front end 20A of the battery pack 20 can be disposed forward of the position of the rear end of the front kick portion 13F.

The present disclosure is not limited to the above embodiment, and can be modified variously without departing from the spirit and scope of the present disclosure. All of them are included in the technical spirit of the present disclosure. For each component of the present disclosure, the number of components is not limited to one, and there may be two or more components, unless otherwise specified in the specification.

What is claimed is:

1. A vehicle underbody structure comprising:
a vehicle frame including a pair of side frames extending in a first direction;
a battery pack disposed in an area surrounded by the side frames, a first kick portion provided on one side of the vehicle frame in the first direction, and a second kick portion provided on the other side of the vehicle frame in the first direction;
a connecting member that connects the battery pack to intermediate portions of the side frames in the first direction; and
a roll mechanism that connects, to the second kick portion, a central portion of the battery pack in a second direction intersecting the first direction on the other side in the first direction to rotate about a rotation axis extending in the first direction.

2. The vehicle underbody structure according to claim 1, wherein an end of the battery pack on the other side in the first direction is located on the other side in the first direction relative to an end of the second kick portion that is closer to the battery pack.
